(19) United States
(12) Patent Application Publication
(10) Pub. No.: US 2005/0084643 A1
(43) Pub. Date: Apr. 21, 2005

(54) Scratch-resistant coating method for optical storage media

(76) Inventors: Helmut Steinberger, Leverkusen (DE); Reiner Vesper, Leichlingen (DE)

Correspondence Address: Bayer Corporation;Patent Department, Bayer Polymers, 100 Bayer Road, Pittsburgh, PA, 15205-9741, US

(21) Appl. No.: 10/493,184

(22) PCT Filed: Oct. 22, 2002
(86) PCT No.: PCT/EP02/11790

(30) Foreign Application Priority Data
Oct. 24, 2001 (DE) 10151853.6

(51) Int. Cl. B32B 3/02

(52) U.S. Cl. 428/64.4

(57) ABSTRACT

An optical data storage medium is disclosed. The medium includes a substrate of a transparent thermoplastic resin and a radiation-cured coating. The coating includes at least one colloidal metal oxide, at least one hydrolysis product of one or more alkoxysilyl acrylate, at least one acrylate monomer, and an optional UV photoinitiator. In a preferred embodiment, the substrate is of polycarbonate. Also disclosed is a process for making the medium.

The invention relates to a method for the transparent scratch resistance coating of optical data medium and data recording materials.

### BACKGROUND OF THE INVENTION

Optical data recording materials have recently come to be used increasingly as a variable recording and/or archiving medium for large volumes of data. In these recording media the recording materials are subject to a locally restricted change in the optical properties such as in the absorption maximum, in the light reflection properties or in the extinction coefficient when they are exposed to the radiation, for example, of a laser beam. The local change can be utilized for information recording.

Since, however, scratches on the read side of the optical data medium also constitute a local change as far as the read laser is concerned, they lead to incorrect information and thus to disruptions in the read-in operation. Although error compensation software can compensate to a certain extent for such read-in errors caused by surface defects, it is known to be unsuitable for compensating relatively severe surface defects.

For optical storage media use is made typically of transparent thermoplastics such as, for example, polycarbonate, polymethyl methacrylate, and chemical modifications thereof. These thermoplastics possess excellent mechanical stability toward dimensional changes, and have a high transparency and impact strength, but also have a certain sensitivity toward scratching. Polycarbonate substrates, accordingly, are sensitive to destruction by scratches, wear, and mechanical erosion. The known sensitivity to scratching of the recording substrates used made it sensible to look for technical methods which, in particular, reduce this sensitivity on the read side.

In order to protect the substrate against physical wear it is advantageous to apply to the substrate material a coating consisting of a scratch-resistant material. The transparent, scratch-resistant coating is required to comply with a number of requirements in respect of ease of application, cure rate, its technical properties, and, not least, its optical and electrical properties. To this end, methods have been proposed to date for applying certain coating materials, which resulted in a certain protection for the substrate against scratching.

Thus in U.S. Pat. No. 4,455,205 and U.S. Pat. No. 4,491,508, and in U.S. Pat. No. 4,198,465, for example, it is proposed to use photocurable acrylates as a scratch-resistant protective coating for plastics. Substrates it is mentioned can be coated are various plastics, metals, and metallized thermoplastics. There is no emphasis on the coating of transparent substrates. For the skilled worker it was not obvious to use the coating compositions described therein for optical transparent data media, since these coating compositions comprise colloidal silica. Optical data media in fact require particularly high transparency (>80% transmission) in the wavelength range of the read and write laser that is used, especially since the light beam, in the case of both operations, passes through the substrate twice. The wavelength range of the laser ought in this case to cover not only visible light to 750 nm but also the ultraviolet region to 300 nm.

Additionally, various protective coatings for optical storage media are described in the technical literature (see therein Zech, Spie “Review of Optical Storage Media” Optical Information Storage, Vol. 177, 1979, pp 56 ff, or, for example, U.S. Pat. No. 5,176,943, JP 02-260145).

These coating materials are composed of a UV-curable or electron-beam-curable acrylate binder which can be admixed optionally with a slip additive and/or with further additives and which is applied optionally with a coat thickness of from 0.004 to 10 microns to the substrate by the spin coating process.

Measures to protect against scratching of CDs and DVDs are described for example in U.S. Pat. No. 5,939,163, which discloses an acrylate coating which is applied in coat thicknesses of 0.01-30 microns, preferably of 0.5-10 microns.

The coating materials described therein do provide a certain protection against scratching; however, these systems have been unable to prevail to date, owing to an inadequate protective effect. Moreover, the systems described tend to become hazy after weathering, i.e., after storage under certain climatic conditions, or to lose some or all of their adhesion to the substrate.

The object of the invention is the creation of a coating on the read side of optical storage media which adheres to the substrate surface, is scratch-resistant, and can be produced economically, and which, owing to its film hardness after curing has taken place, protects the substrate surface against mechanical scratching, is resistant to external environmental effects referred to as “weathering” (climate testing), and does not introduce any disadvantages of a technical nature, such as, for example, an increase in birefringence, signal attenuation, or bending of the disks, discoloration or clouding of the surface, or alteration in readability or writability by a focused laser beam.

The known systems based on organic photocurable acrylates give coatings having a thickness of between 7 and 12 microns which contract severely during the cure and, as a result of the contraction that occurs, distort the polycarbonate sheet, meaning that the information carriers become unplayable or unwritable/unreadable.

Although suitable measures can be used to reduce the coat thickness, this results in a considerable drop in scratch resistance.

It has now surprisingly been found that, using special UV-curable inorganic lacquer systems, effective adhesion of the coating to the substrate materials, sufficient transparency, and superior scratch resistance at low coat thicknesses is achieved, which does not alter the geometry of the optical data media at all, or alters it only within the bounds of the allowable tolerances.

The acrylate resin composition used in accordance with the invention comprises alkoxysilyl acrylate-modified metal oxides which are formed by reacting hydrolysis products of alkoxysilyl acrylates with metal oxides.

The present invention accordingly provides optical data storage media which have been provided with a coating obtained by radiation curing a radiation-curable coating composition that comprises at least one colloidal metal oxide, at least one hydrolysis product of at least one alkoxysilyl acrylate, at least one acrylate monomer, and at least one photoinitiator.

The radiation-curable coating compositions comprise advantageously:
(A) 1% to 60% by weight of at least one colloidal metal oxide,
(B) 0.1% to 50% by weight of at least one material formed by hydrolysis of at least one alkoxysilyl acrylate, preferably of the formula (I),
(C) 25% to 90% by weight of at least one acrylate monomer, preferably of the formula (II), and
(D) 0.01% to 15% by weight of at least one photoinitiator, based on the total mass of the coating composition.

Colloidal metal oxides (A) advantageously include: silicon dioxide, zirconium dioxide, titanium dioxide, aluminum oxide, and zinc oxide.

Preference is given to colloidal silicon dioxide. The colloidal metal oxides are used advantageously as a dispersion of metal oxide particles in the submicron range in an aqueous and/or organic solvent medium. Such colloidal dispersions of metal oxide particles are obtainable either by hydrolyzing the corresponding metal alkoxides or, starting from aqueous solutions of the corresponding alkali metalates, by removing the alkali metal ions by means of ion exchangers. Depending on the process conditions, colloidal aqueous or alcoholic-aqueous dispersions of the metal oxides are obtained with a particle size distribution of between 1 and 1000 nm. For use in the coating materials of the invention the particle sizes ought preferably not to be above 100 nm. A typical particle size distribution of the silicon dioxide particles is between 5 and 40 nm.

The particle size distribution can be determined either by means of scanning electron microscopy, by subjecting a counted quantity of particles to optical measurement, or by means of electronic counting instruments (e.g., Coulter-Multisizer 3, Beckman Coultert Inc. or Laser Diffraction Sizer CDA 500, Malvern Instruments, Ltd. UK). For very small particles (<100 nm) the use of Zeta-Civers has been found the most precise method of measuring the particle sizes.

The metal oxides, in particular the SiO₂ particles, contain tetrafunctional (Q) metal or silicon atoms and provide the hardness to the coating compositions. In the sol state, these colloidal metal oxides possess hydroxyl functions on their surface.

These functions are able to react by condensation reaction with the—for example—trifunctional acrylate silanetriols of the formula (I) (formed by hydrolysis from trialkoxysilane-modified acrylates, “silicone-modified acrylates”) to form particles having a core-shell structure.

Dispersions of colloidal silicon dioxide are purchasable, for example, from a variety of manufacturers such as DuPont, Nalco Chemical Company or Bayer AG. Colloidal dispersions of silicon dioxide are available in either acidic or alkaline form. For preparing the coating materials it is preferred to use the acidic form, since these provide better properties to the coatings than the alkaline forms.

Nalcoag 1034A.RTM. is one example of a colloidal silicon dioxide having satisfactory properties. It contains about 34% by weight of SiO₂. In the examples the figures reported also include the water fraction. Thus, for example, 520 grams of Nalcoag 1034A.RTM. represent approximately 177 grams of SiO₂.

The coating compositions of the invention preferably contain from 1 to 60% by weight of colloidal metal oxides, more preferably 5 to 40% by weight, based in each case on the total amount of the coating composition.

The component (B) used in accordance with the invention preferably represents a hydrolysis product of a silyl acrylate of the general formula (I): 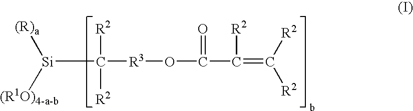
in which
a is an integer from 0 to 2, preferably 0,
b is an integer from 1 to 3, preferably 1, and
the sum of a+b amounts to 1 to 3, preferably 1.

In the formula (I) R is a straight-chain or branched alkyl radical having 1 to 8 carbon atoms, a cycloalkyl radical having 3 to 8 carbon atoms or an unsubstituted or substituted aryl radical having 6 to 10 carbon atoms in the aryl moiety. If a plurality of groups R is present (a=2) the radicals R can be identical to or different from one another. The straight-chain or branched alkyl radical having 1 to 8 carbon atoms includes for example methyl, ethyl, propyl, butyl, and so on.

Preferred radicals for R are methyl, ethyl, propyl, cyclohexyl, hexyl, octyl, isopropyl, and isobutyl. Preference is given to the alkyl radicals. With particular preference R is methyl and ethyl.

The unsubstituted or substituted aryl radical having 6 to 10 carbon atoms includes for example phenyl or naphthyl radicals, which may be substituted by one or more, preferably from one to three, substituents selected from the group consisting of alkyl groups having 1 to 6 carbon atoms and halogen atoms, such as fluorine, chlorine, bromine or iodine, such as, for example, phenyl, tolyl, xylyl, naphthyl, chlorophenyl, and so on.

A preferred aryl radical for R is phenyl.

R¹ in the general formula (I) is hydrogen, a straight-chain or branched alkyl radical having 1 to 8 carbon atoms, a cycloalkyl radical having 3 to 8 carbon atoms or an unsubstituted or substituted aryl radical having 6 to 10 carbon atoms in the aryl moiety, and, if there is a plurality of groups R¹ (a+b>1), they can be identical to or different from another.

With regard to the straight-chain or branched alkyl radical having 1 to 8 carbon atoms or to the unsubstituted or substituted aryl radical having 6 to 10 carbon atoms and to their preferred definitions, reference may be made to the details given in relation to the substituent R.

Preferably R¹ is methyl or ethyl.

R² in the general formula (I) is hydrogen, a straight-chain or branched alkyl radical having 1 to 8 carbon atoms or an unsubstituted or substituted aryl radical having 6 to 10 carbon atoms, and the groups R² can be identical to or different from one another.

With regard to the straight-chain or branched alkyl radical having 1 to 8 carbon atoms or to the unsubstituted or substituted aryl radical having 6 to 10 carbon atoms and to their preferred definitions, reference may be made to the details given in relation to the substituent R.

Preferably R² is hydrogen and/or methyl, and in particular the carbon atom adjacent to the carbonyl carbon atom may carry a methyl group as R² (methacrylates). With preference, therefore, the substituents R² are all hydrogen, and the substituent R² which is located on the carbon atom adjacent to the carbonyl carbon atom can also be methyl.

R³ in the general formula (I) is a single bond or a straight-chain or branched, unsubstituted or substituted alkylene radical (alkanediyl radical) having 1 to 8 carbon atoms in the alkylene radical or is an unsubstituted or substituted arylene radical (aryldiyl radical) having 6 to 10 carbon atoms in the arylene radical. Optionally the alkylene radical is substituted preferably by from one to three substituents, more preferably one substituent, selected from the group consisting of halogen and hydroxyl. Optionally the arylene radical is substituted preferably by from one to three radicals, more preferably one radical, selected from the group consisting of alkyl groups having 1 to 6 carbon atoms, halogen atoms, such as fluorine, chlorine, bromine or iodine, and hydroxyl.

Examples of R³ include:
linear alkylene radicals, such as methylene, ethylene, trimethylene, tetramethylene, and so on, preferably unbranched radicals, unbranched or branched halogenated alkylene radicals having 2 to 8 carbon atoms, unbranched or branched hydroxylated alkylene radicals having 2 to 8 carbon atoms, arylene radicals having 6 to 10 carbon atoms, e.g., phenylene (1,2-, 1,3-, and 1,4-phenylene), tolylene, naphthylene, and so on, halogenated arylene radicals having 6 to 10 carbon atoms in the arylene moiety, and so on.

Preferably R³ is a single bond, methylene or ethylene.

The silyl acrylates of the general formula (I) used in accordance with the invention are known per se and described for example, as well as elsewhere, in U.S. Pat. No. 4,491,508, hereby to that extent incorporated by reference.

The silyl acrylates of the formula (I) preferably include acrylate and methacrylate compounds, such as:
CH₂═CCH₃CO₂—CH₂—Si(OCH₂CH₃)₃,
CH₂═CCH₃CO₂—CH₂—Si(OCH₃)₃,
CH₂═CCH₃CO₂—CH₂CH₂—Si(OCH₂CH₃)₃,
CH₂═CCH₃CO₂—CH₂CH₂—Si(OCH₃)₃,
CH₂═CHCO₂—CH₂CH₂—Si(OCH₂CH₃)₃,
CH₂═CHCO₂—CH₂CH₂—Si(OCH₃)₃,
CH₂═CCH₃CO₂—CH₂CH₂CH₂—Si(OCH₂CH₃)₃,
CH₂═CCH₃CO₂—CH₂CH₂CH₂—Si(OCH₃)₃,
CH₂═CHCO₂—CH₂CH₂CH₂—Si(OCH₂CH₃)₃,
CH₂═CHCO₂—CH₂CH₂CH₂—Si(OCH₃)₃,
CH₂═CCH₃CO₂—CH₂CH₂CH₂CH₂—Si(OCH₂CH₃)₃,
CH₂═CCH₃CO₂—CH₂CH₂CH₂CH₂—Si(OCH₃)₃,
CH₂═CHCO₂—CH₂CH₂CH₂CH₂—Si(OCH₂CH₃)₃,
CH₂═CHCO₂—CH₂CH₂CH₂CH₂—Si(OCH₃)₃, etc.

The hydrolysis products (B) of the alkoxysilyl acrylates that are present in the coating composition used in accordance with the invention, preferably of the formula (I), are produced by contacting the alkoxysilyl acrylates with water.

These acrylates are partially or fully hydrolyzed alkoxysilyl acrylates. The hydrolysis produces the corresponding hydroxysilyl acrylates, which are able to react with one another and with the hydroxyl groups of the colloidal metal oxides, with condensation.

It is assumed that the hydrolysis products react with the colloidal metal oxides to form Si—O-metal bonds.

As described later on in more detail in connection with the preparation of the coating compositions of the invention, the hydrolysis products of the silyl acrylates can be formed before or during the preparation of the coating compositions used in accordance with the invention.

The amount of the material (B) used in accordance with the invention in the coating composition used in accordance with the invention is advantageously 0.1 to 50% by weight, preferably 1 to 15% by weight, based in each case on the total amount of the coating composition.

The acrylate monomers (C) used in accordance with the invention possess preferably the general formula (II): 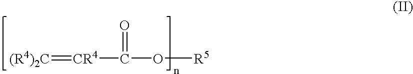
in which n is a number from 1 to 6, R⁴ is hydrogen, a straight-chain or branched alkyl radical having 1 to 8 carbon atoms or an unsubstituted or substituted aryl radical having 6 to 10 carbon atoms in the aryl moiety, and the substituents R⁴ can be identical to or different from one another, and R⁵ is an unsubstituted or substituted mono- to hexavalent organic radical.

n is preferably an integer from 1 to 4, with particular preference from 2 to 4.

With regard to the straight-chain or branched alkyl radical having 1 to 8 carbon atoms or to the unsubstituted or substituted aryl radical having 6 to 10 carbon atoms, for R⁴, and to their preferred definitions, reference may be made to the details given in relation to the substituent R of the formula (I).

Preferably R⁴ is hydrogen and/or methyl, and in particular the carbon atom adjacent to the carbonyl carbon atom may also carry a methyl group as R⁴ (methacrylates). With preference, therefore, the substituents R⁴ are all hydrogen (acrylates), and the substituent R⁴ located on the carbon atom adjacent to the carbonyl carbon atom may also be methyl (methacrylates).

R⁵ includes mono- to hexavalent, preferably di- to tetravalent, organic radicals, which optionally may be substituted. The valence corresponds to the number of acrylate groups n. Preferably R⁵ includes unsubstituted or substituted straight-chain or branched aliphatic to aromatic hydrocarbon radicals having 1 to 20, preferably 1 to 10, carbon atoms. With regard to the divalent radicals reference may be to the radicals mentioned above for R³.

R⁵ optionally has preferably one to three substituents, such as halogen or hydroxyl.

The acrylate monomers of the formula (II) include mono- and polyfunctional acrylate monomers.

Monoacrylates include optionally hydroxyl-substituted alkyl acrylates and alkyl methacrylates, such as hydroxyethyl acrylate, for example, etc. Within the formulations of the invention the acrylate monomers of the formula (II) are present in a fraction of at least 5% by weight to 25% by weight, preferably 5 to 10% by weight, in order to ensure increased adhesion to the substrates used.

In the coating composition used in accordance with the invention there is preferably at least one acrylate having at least two ethylenically unsaturated groups, optionally in combination with a mono- or polyfunctional acrylate.

Examples of the polyfunctional acrylates of the formula (II) include:
diacrylates of the formulae: 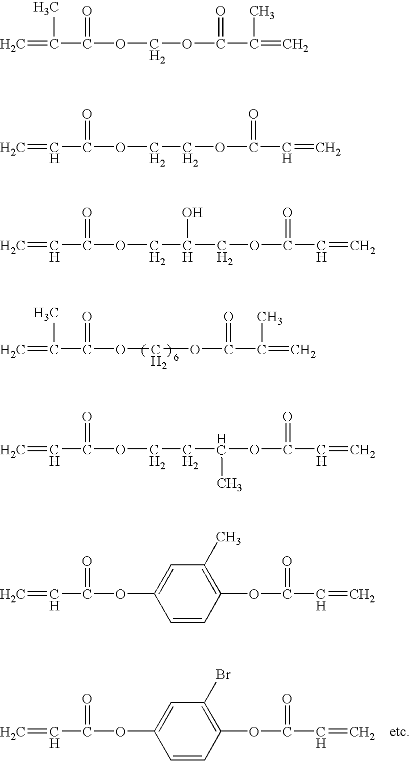
   Triacrylates of the formulae: 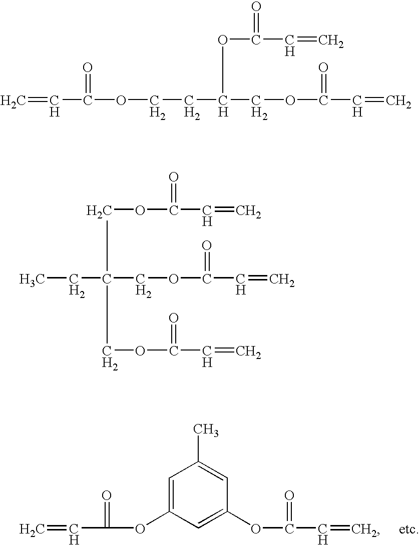
   Tetraacrylates of the formulae:

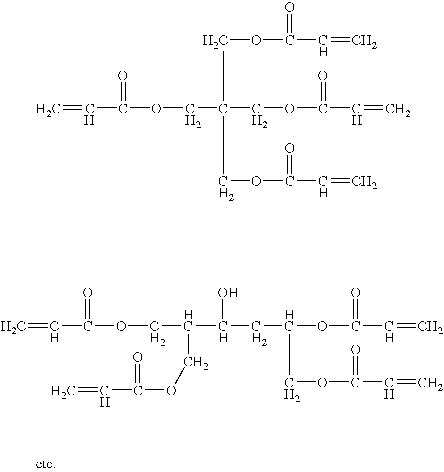

Acrylates of this kind are known per se, and reference may be made, for example, to those which are described in U.S. Pat. No. 4,491,508 and also U.S. Pat. No. 4,198,465.

The coating composition used in accordance with the invention preferably comprises a mixture of two or more polyfunctional acrylate monomers of the formula (II), more preferably a diacrylate and a higher polyfunctional acrylate. Coating compositions comprising a mixture of diacrylates and higher polyfunctional acrylates advantageously have a weight ratio of diacrylate to higher polyfunctional acrylate of from 0.5:99 to about 99:0.5, with particular preference from 1:99 to 99:1. For example, a mixture of a diacrylate and a triacrylate of the general formula (II) can be used.

Exemplary mixtures of diacrylate and polyfunctional acrylate include hexanediol diacrylate with trimethylolpropane triacrylate (TMPTA), hexanediol diacrylate with pentaerythritol tetraacrylate, diethylene glycol diacrylate with pentaerythritol triacrylate, and diethylene glycol diacrylate with trimethylolpropane triacrylate. Coating compositions comprising two polyfunctional acrylate monomers of the formula (II) are particularly preferred.

The amount of the acrylate monomer (C) in the coating composition used in accordance with the invention is advantageously 25 to 90% by weight, preferably 40 to 85% by weight, based in each case on the total amount of the composition.

In one particular embodiment of the invention the fraction of the monofunctional acrylates as components (C) (n=1), based on the total amount of component (C), is 5 to 50% by weight, preferably 5 to 25%, more preferably 5 to 10% by weight.

The photocrosslinkable coating compositions used in accordance with the invention comprise an amount necessary for photosensitization of at least one photoinitiator (D), i.e., an amount suitable for effecting UV photocuring. Generally this required amount is situated within a range between 0.01 to 15% by weight, preferably 0.1 to 10% by weight, 1 to 8% by weight, more preferably 1.5 to 7% by weight based on the sum of all constituents in the coating composition. Where larger amounts of photoinitiator are used, coating compositions which cure more rapidly are obtained.

As photoinitiators (D) it is possible, for example, to use those specified in U.S. Pat. Nos. 4,491,508 and 4,455,205. Photoinitiators, such as methyl benzoylformate, for example, which are suitable for use in accordance with the invention are available under a variety of trade names.

The UV-curing coating compositions used in accordance with the invention are composed preferably essentially of components (A) to (D). However, it is known to the skilled worker that it is also possible where appropriate to add further, conventional additives to the coating compositions used in accordance with the invention, in a fraction which does not adversely affect the achievement of the inventive object, such as, for example, soluble salts, soaps, amines, nonionic and anionic surfactants, acids, bases, and substances which counter gelling. Furthermore, various flow assistants and also wetting agents, light stabilizers, and dyes can be added.

Additives of this kind are described, for example, in U.S. Pat. Nos. 4,491,508 and 4,455,205.

The various surface-active auxiliaries which can be added to the coating compositions are known per se and require no further explanation. They are described for example in:
Kirk-Othmer “Encyclopedia of Chemical Technology”, Vol. 19, Interscience Publishers, New York, 1969, pp. 507-593, and “Encyclopedia of Polymer Science and Technology”, Vol. 13, Interscience Publishers, New York, 1970, pp. 477-486. Further nonacrylic monomers such as N-methylpyrrolidone or styrenes serve, like some monoacrylates, e.g., isobornyl acrylate, phenoxyethyl acrylate or hydroxyethyl methacrylate, both to improve the properties of the cured product film, by raising its flexibility, and to enhance its adhesion to the substrate materials. They additionally have a viscosity-lowering effect on the mixture formulation.

The UV-curable coating compositions used in accordance with the invention can be prepared by mixing together components (A) to (D) and any further components present.

In one mixing operation the silyl acrylate can be hydrolyzed in the presence of the aqueously colloidal metal oxide and of the water-miscible alcohol. In a further process step the aqueous colloidal metal oxide can be added to the silyl acrylate, which has been hydrolyzed in aqueous-alcoholic solution either at room temperature or at the reflux temperature of the solvent used.

Suitable solvents include, for example, all water-miscible alcohols and also alcohol-solvent azeotropes. Examples of such solvents are isopropyl alcohol, 4-methoxypropanol, n-butanol, 2-butanol, ethanol, and similar alcohols.

In order to obtain a solvent-free product an azeotropic mixture of water and alcohol is distilled from the formulation. In those cases where no alcohol has been used in the original hydrolysis mixture, the alcohol required for the azeotropic distillation must be added subsequently, in order to remove all of the water present in the mixture.

The present invention further relates to a method of coating optical data media such as, for example, CD, Super Audio CD, CD-R, CD-RW, DVD, DVD-R, DVD-RW, and DVR on the read side. A systematic overview of the optical and magnetooptical data media systems known at the present time is given in the table below. Preferred systems are: CD-R, CD-RW, DVD, DVD-R, DVD-RW, and DVR.

| Types | Data input | Properties | Examples |
|---|---|---|---|
| CD-ROM | Data pre-entered | Data not erasable | Structure and |
| DVD- | by the | | information storage |
| ROM | manufacturer | | analogous to CD-DA |
| | | | (Digital Audio) |
| CD-R | Data can be | Data not erasable | Polymer substrate (PC) |
| DVD-R | written by the | Data not | with memory layer of |
| | user | rewritable | metal/polymer |
| | | | colorant/polymer |
| CD-RW | Data can be | Data not erasable | Polymer substrate (PC) |
| DVD-RW | written by the | Data rewritable | with memory layer |
| DVR | user | | based on |
| | | | Magneto-Optical |
| | | | Recording (MO-R) |
| | | | Phase-Change |
| | | | Recording (PC-R) |

CD-DA=Compact Disk-Digital Audio
CD-ROM=Compact Disk-Read Only Memory
DVD-ROM=Digital Versatile Disk-Read Only Memory
CD-R=Compact Disk-Recordable
DVD-R=Digital Versatile Disk-Recordable
CD-RW=Compact Disk-ReWritable
DVD-RW=Digital Versatile Disk-ReWritable
DVR=High Density Disk-Recordable
to achieve scratch-resistant coatings on these optical data media using the UV-curable coating compositions described above.

The optical data storage media coated in accordance with the invention are composed generally of transparent thermoplastics such as polycarbonate based on bisphenol A (BPA-PC), polycarbonate based on trimethylcyclohexylbisphenol polycarbonate (TMC-PC), fluorenyl polycarbonate, polymethy methacrylate, cyclic polyolefin copolymer COC 513 (manufacturers: Ticona GmbH, Nippon Zeon, Japan, Japan Synthetic Rubber, Japan), hydrogenated polystyrenes (BPS) (manufacturer: Dow Chemical), and amorphous polyolefins and polyesters (manufacturer: Kodak Corp., USA).

In connection with coating of optical data media in disk form, such as CD, DVD, and DV-R, the UV-curable coating compositions are advantageously applied to the individual disks by a spin coating process and subsequently cured by exposure to UV rays.

For this purpose, preferably, the disk, which either in a chamber kept free of dust within a manufacturing line or, if it has been produced in a preceding step, following pretreatment with deionized air, has the coating material deposited on it, in the quantity required for the process, in a spin coating chamber, the coating material being in the form of a ring of liquid or a spiral, and subsequently, by increasing the speed of rotation of the substrate to rotational speeds of from 1000 to 10,000 per minute, the coating material is distributed uniformly over the substrate surface within from 1.0 to 10 seconds and the excess spun off. It is possible with the aid of a rotational speed program to configure the spin coating operation in such a way that the radial distribution of the coat thickness is substantially constant.

This operation produces on the substrate surface a uniform film of liquid with a coat thickness of between 0.001 and 100 microns. The achievable coat thickness is dependent on the rheological properties of the coating material, such as the viscosity, on the rotational speed of the spin coating plate, and on the period of exposure to high rotational speeds during the spin coating operation.

The uncured film on the surface of the substrate ought to be cured by means of a suitable type of radiation, such as UV or electron beams, immediately after the spin coating operation, but preferably by means of ultraviolet radiation; advantageously at room temperature to about 45° Celsius. Examples of suitable UV radiation sources in this context are unpulsed radiation sources. Pulsed radiation sources are not used here in the practice of the UV radiation curing. In principle electron beams (EB) can be used for curing radiation-crosslinkable coating materials, but in practice EB curing installations have proven too large or too slow in terms of the operating time.

In the system employed the radiative output of the UV lamps used is variable from 1000 to 20,000 watts, preferably about 1600 to 2200 watts (for CD, CD-R, CD-RW, and DVD). The UV lamp used (manufacturer: Singulus; type: 200 BTZ/DF) is a high-pressure mercury lamp with a variable output of from 1000 to 20,000 watts/h. An alternative possibility is to use other standard Hg lamps, provided they emit a corresponding output in the curing-relevant UV range (250 to 400 nm, but preferably in the range from 360 to 380 nm).

The use of an inert gas atmosphere, such as a nitrogen atmosphere, which is otherwise usual with this curing process is not necessary in the case of these methods.

The thickness of the resultant cured coating ought preferably to amount to not more than 100 microns, in order to ensure sufficient curing through volume. As a result of contraction in the course of curing through volume, higher coat thicknesses can lead to deformation (dishing) of the optical data media, with the consequence that they are no longer readable or writable. Preferred coat thicknesses are situated in a range between 100 and 1 microns. Particularly preferred coat thicknesses are situated in a range between 10 and 3 microns.

The coating composition used in accordance with the invention generally represents the outer coat of the write and read side, i.e., the side of the coated optical data medium through which the laser beam passes. It can, however, also be used both to coat the read and write side and to coat the opposite side.

The coatings produced in accordance with the invention offer a range of advantages over the state of the art.

They have a particularly good adhesion to their substrates, in particular to polycarbonate, and in particular after aging by means of the climate test for CD, DVD, and DV-R.

The coatings produced in accordance with the invention further possess an improved hardness and scratch resistance as compared with the coatings used in the state of the art.

Moreover, in the case of CDs or DVDs, the coatings produced in accordance with the invention cause neither any electronic noise nor any additional errors which might adversely affect the readout accuracy or the writability.

The examples which follow are intended to illustrate the invention.

In the examples the following test methods have been employed:

1. Climatic Test

In the climatic test the coated CDs or DVDs are stored under defined, artificially set climatic conditions (temperature: 70° Celsius; relative humidity: 50%; storage time: 96 hours; in an intensified version of this test the CDs or DVDs are stored under different conditions: temperature: 80° Celsius; relative humidity: 95%, storage time: 96 hours; in a further-intensified version of this test the CDs or DVDs are stored under different conditions: temperature: 70° Celsius; relative humidity: 90%; storage time: 500 hours). After the end of the respective period of storage under the particular specified conditions the CDs or DVDs are left under standard conditions for 24 hours and then the deviation from planarity is measured. In addition, the condition of the coating is inspected visually. No areas with delamination of the coating should be visible.

In addition, the crosshatch test is used to examine the adhesion of the coating before and after the climatic test has been carried out. Said crosshatch test is carried out by making parallel incisions into the CD/DVD material using a multiple blade. Thereafter the disk is rotated by 90° and the operation is repeated. This produces a crosshatch pattern with 1 mm² patterns on the coating. Using an adhesive tape, of type 3M Scotch 710, for example, the crosshatching is briefly covered and then the tape is removed.

A sample fails the crosshatch test if one of the squares produced is detached from the substrate by the adhesive tape. This test is repeated three times for each sample.

2. Scratch Resistance

The scratch resistance is determined by the pencil hardness method and by the Taber Abrader method.

In the case of the pencil hardness method commercially customary pencil leads with a diameter of 2 mm are abraded with fine corundum paper on two sides so as to form a sharp edge. This sharp edge is placed on the coating by hand and advanced. If the pencil lead used is harder than the coating under investigation, a groove is produced on the surface of the coating; if the pencil lead is softer than the substrate under investigation, the lead leaves no groove (scratch). The hardness of the coating is taken to be that pencil hardness which was just unable to produce any scratching of the coating surface. The test is repeated three times for each sample.

The Taber Abrader test uses circular disks with a central hole. The Taber Abrader is fitted with CS-10F wheels, which are reconditioned every 500 cycles by running them for 15 cycles on an S-111 disk. The weights used in this test are 500 g. For each coated disk, the haze is measured using a GARDNER haze meter at 4 sites of future abrasion. The sample is abraded over a certain number of cycles and is cleaned to remove adhering particles. The difference in haze is determined from the haze value determined by the same procedure, minus the initial haze, as delta haze. Each measurement is carried out on 5 samples in each case.

### EXAMPLE 1

A mixture of 50 parts of t-butanol, 16.6 parts of Nalcoag 1034A, a product of the Nalco Company, Oak Brook, Ill., and 1 part of gamma-methacryloyloxypropyltrimethoxysilane (MAPTMS) was heated at reflux for 5 minutes. After it had cooled to room temperature, 13.2 parts of a 1:1 mixture of hexanediol diacrylate and trimethylolpropane triacrylate were added. The solvent was subsequently distilled off under reduced pressure. After about half of the solvent had distilled off, an additional 30 parts of t-butanol were added. The total solvent and also water were distilled off. This gave a clear solution. 1.5 parts of alpha,alpha-diethoxyacetophenone were added to 100 parts of this solution.

The resulting UV-curable coating material was applied to CD-R disks originating from in-house production in an automatic coating unit from STEAG-Hamatech, type DVD-R2500, in the way, and coated and cured for 2 seconds with a UV lamp output of 2200 watts/h.

The properties of the coating obtained are shown Table 1.

### EXAMPLE 2

A mixture of 52 g of Nalcoag 1034A (colloidal silica sol) and 10 g of gamma-methacryloyloxypropyltrimethoxysilane, in solution in 80 g of isobutanol and 80 g of isopropanol, was heated at reflux for 30 minutes. After the mixture had cooled to room temperature, a drop of a 50% strength sodium hydroxide solution was added. The solvent was removed under reduced pressure. The viscous resin was taken up in 3.2 g of diethylene glycol diacrylate, 3.2 g of trimethylolpropane triacrylate and 4 g of N-vinylpyrrolidone. After the solvents and the water had been evaporated, 2.1 g of benzophenone and 2.1 g of methyldiethanolamine per 100 g of the resulting reaction mixture were added as photoinitiator. This coating material was applied to a CD-RW in an automated coating unit from STEAG-Hamatech, type DVD-R2500, and coated and cured, in the way indicated in Example 1.

The properties of the coating obtained are shown Table 1.

### EXAMPLE 3 (COMPARATIVE EXAMPLE)

For comparison a scratch-resistant lacquer from the market was used, which is said to be particularly suitable for the lacquering of transparent thermoplastics. This lacquer is available under the designation UVT 200 (manufacturer: Red Spot and Varnish Co., Evansville, USA).

Application to the substrate took place under the same conditions as for the application of the lacquers of the invention. Spinning in the spin coater took place at 3000 rpm for 2 sec. In this case a coat thickness of 8.5 microns (μm) was obtained.

The properties of the coating obtained are shown Table 1.

### EXAMPLE 4 (COMPARATIVE EXAMPLE)

For comparison a lacquer specially recommended for CD coating (type: Daicure Clear SD-715, manufacturer: Dainippon Ink & Chemicals, Inc., Japan) was applied to CD-R in the manner depicted in Example 3. After curing, a coat thickness of 5 microns (μm) was measured.

Table 1 below compares the mechanical data of the coating obtained.

TABLE 1

| | Crosshatch | Pencil | Delta Haze | |
|---|---|---|---|---|
| | test | test | % 500 Taber | Thickness |
| | adhesion | hardness | cycles | (microns) |
| Example 1 | Passed | 2H | 9.1 | 5.5 |
| Example 2 | Passed | 2H | 8.7 | 3.9 |
| Example 3 | Passed | F | 40.0 | 8.5 |
| (comparative) | | | | |
| Example 4 | Passed | H | 35.9 | 5.0 |
| (comparative) | | | | |
| PC without | Failed | B | 54.4 | failed |
| coating | | | | |

Table 2 depicts the electrical properties and the climate resistance of the coated substrates.

TABLE 2

| | | | | Weathering |
|---|---|---|---|---|
| | BLER | Radial | Deviation | (80° C./ |
| | (CD-R) | noise (nm) | (° over radius) | 95% RH/96 h) |
| Example 1 | 12 | 12 | minus 0.3 | passed |
| Example 2 | 3 | 5 | minus 0.05 | passed |
| Example 3 | 25 | >20 | plus 1.5 | bent, white |
| (comparative) | | | | |
| Example 4 | 15 | >18 | plus 1.0 | bent, whitish |
| (comparative) | | | | |
| PC without | 3 | 4 | plus 0.1 | n.d. |
| coating | | | | |

BLER=Block Error Rate; change compared with uncoated product; correction units/sec which are necessary for read correction. BLER is reported as the rate of errors which occurred per second. The specification limit is 220 errors per second, with a specification of 50 errors per second being recommendable for CD-ROMs as the maximum average value, and 100 errors per second as the maximum peak value. BLER is crucial in that the number of errors occurring is to be minimized in order to ensure data integrity.

Radial Noise (RN)=track change measured in accordance with ISO/IEC 10 149; has a limit value of 30 nanometers within a bandwidth of 500 to 2500 Hz. RN occurs if the track is damaged. In the case of high RN peaks, the servo controller may jump tracks. A high average RN level is an indicator of poorly defined pits.

Deviation (DEV)=(height) deviation, measured in angular degrees (°), from the plane, as viewed from the metallized top face. DEV is measured at 10 different diameters, distributed over the surface of the disk. It is given by the angle between the central point of the disk and the disk area deviating from the plane. The specification for the DEV allows a height deviation with respect to the plane of +/−0.5 mm in the edge region for both blank and recorded CD-Rs. Excessive values for the deviation give rise to problems in focusing and hence the loss of the HF signal.

Despite the fact that coating composition in accordance with comparative test was applied in a greater thickness, it exhibits a significant lower hardness and a more severe contraction, leading to the distortion of the optical data medium.

1. Optical data storage media, characterized in that they have been provided with a coating obtained by radiation curing a radiation-curable coating composition that comprises at least one colloidal metal oxide, at least one hydrolysis product of at least one alkoxysilyl acrylate, at least one acrylate monomer, and if desired a UV photoinitiator.

2. Optical data storage media of claim 1, wherein the radiation-curable coating composition is a UV-curable coating composition which comprises at least one UV photoinitiator.

3. Optical data storage media of claim 2, wherein the UV-curable coating composition contains
(A) 1% to 60% by weight of at least one colloidal metal oxide,
(B) 0.1% to 50% by weight of at least one hydrolysis product of an alkoxysilyl acrylate,
(C) 25% to 90% by weight of at least one acrylate monomer, and
(D) 0.01 % to 15% by weight of at least one UV photoinitiator,
based in each case on the total amount of the composition.

4. Optical data media of claim 1 being optical data media based on polycarbonates.

5. Optical data media of claim 1 being CDs, DVDs or DVD-Rs based on polycarbonates.

6. Method of producing optical data media of claim 1 characterized in that the radiation-curable coating composition is applied to the substrate, adjusted to the desired thickness by a spin coating process, and subsequently cured.

7. Cancelled.

8. An optical data storage medium comprising a substrate of a transparent thermoplastic resin and a radiation-cured coating that includes at least one colloidal metal oxide, at least one hydrolysis product of one or more alkoxysilyl acrylate, at least one acrylate monomer, and an optional UV photoinitiator.

9. The optical data storage media of claim 8, wherein the radiation-curable coating composition is a UV-curable coating composition and contains a UV photo initiator.

10. The optical data medium of claim 8 wherein thermoplastic resin is polycarbonate.

11. The optical data medium of claim 10 in the form of a member selected from the group consisting of CD, DVD and DVD-R.

12. A method of producing an optical data medium comprising applying to a substrate of a transparent thermoplastic resin a radiation-curable coating composition, the application by a spin coating process, and curing the coating.
